(19) United States
(12) Patent Application Publication
(10) Pub. No.: US 2016/0278308 A1
(43) Pub. Date: Sep. 29, 2016

(54) POWER WEDGE DEVICE

(71) Applicant: Steven E. Jacob, Altura, MN (US)

(72) Inventor: Steven E. Jacob, Altura, MN (US)

(21) Appl. No.: 15/062,311

(22) Filed: Mar. 7, 2016

Related U.S. Application Data
(60) Provisional application No. 62/137,927, filed on Mar. 25, 2015.

(51) Int. Cl. A01G 23/08

(52) U.S. Cl. CPC A01G 23/08

(57) ABSTRACT

A power wedge device includes a base, a screw-type cone wedge mounted to the base and including a threaded cone portion that tapers to a pointed tip. A motor is mounted to the base and coupled to the screw-type cone wedge to rotatably drive the threaded cone portion. A counter-rotational member is coupled to the base and is configured to ground the screw-type cone wedge so as to prevent the screw-type cone wedge from spinning the motor and the base.

### CROSS REFERENCE TO RELATED APPLICATION

The present application is based on and claims the benefit of U.S. provisional patent application Ser. No. 62/137,927, filed Mar. 25, 2015, the content of which is hereby incorporated by reference in its entirety.

### BACKGROUND

One of the elements of logging is the process of felling or downing individual trees. Trees may be felled by making a face cut or notch cut and a back cut opposite the notch cut. A wedge can then be hammered into the back cut so that the tree falls towards the side of the notch cut.

The discussion above is merely provided for general background information and is not intended to be used as an aid in determining the scope of the claimed subject matter.

### SUMMARY

A power wedge device includes a base, a screw-type cone wedge mounted to the base and having a threaded cone portion that tapers to a pointed tip. The tree felling device further includes a motor mounted to the base and coupled to the screw-type cone wedge to rotatably drive the threaded cone portion and a counter-rotational member coupled to the base and configured to ground the screw-type cone wedge so as to prevent the screw-type cone wedge from spinning the motor and the base.

A power wedge device for felling a tree includes a screw-type cone wedge mounted to a base and including a threaded cone portion that tapers to a tip. The tip engages with a back cut on a tree to be felled. A motor is mounted to the base and coupled to the screw-type cone wedge to rotatably drive the threaded cone portion. An elongated rod extends from the base and terminates at a distal end. The distal end of the elongated rod engages with a ground so the elongated rod acts as a counter-rotational member to prevent the screw-type cone wedge from spinning the base and the motor.

A method of felling a tree includes cutting a notch cut into a base of a tree on the side of the tree to which the tree should fall and cutting a back cut into a base of the that is opposite the notch cut but does not intersect the notch cut. A pointed tip of a screw-type cone wedge is placed on an outer surface of the tree at the back cut and the screw-type cone wedge is powered so that a threaded cone portion of the screw-type cone wedge drills into the back cut until the tree falls.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view of a power wedge device in accordance with one embodiment.

FIG. 2 is a left side view of the power wedge device of FIG. 1.

FIG. 3 is a right side view of the power wedge device of FIG. 1.

FIG. 4 is a top view of the power wedge device of FIG. 1

FIG. 5 is a bottom view of the power wedge device of FIG. 1.

FIG. 6 is a front view of the power wedge device of FIG. 1.

FIG. 7 illustrates an enlarged side view of the screw-type cone wedge illustrated in FIGS. 1-6.

FIG. 8 illustrates a schematic diagram of preparing a tree for felling with the power wedge device illustrated in FIGS. 1-6.

FIG. 9 illustrates a schematic diagram of felling a tree using the power wedge device illustrated in FIGS. 1-6.

### DETAILED DESCRIPTION OF ILLUSTRATIVE EMBODIMENTS

Forestry or logging is a dangerous business. The most dangerous part is felling trees with a chainsaw, hammer and wedge. The unpredictable nature of how a tree will ultimately fall combined with the position the person who is operating the chainsaw and/or the wedge creates an element of danger. For example, the tree being felled may be on a steep hill, with many other small trees around it, or the tree being felled may be surrounded by snowy or wet conditions, making escape from the falling tree difficult and dangerous. Still further, there may be other tree tops interfering and/or other trees leaning on the target tree adding more difficulties and dangers to the process.

Embodiments of a power wedge device, as will be described in detail below, allow an operator to prepare a tree for felling according to a standard process, insert the power wedge device, walk away from the tree to be felled and remotely operate the device from a safe distance. In one embodiment, the power wedge device is a remote controlled wedge. It replaces the work previously done at the base of the tree with a hammer and wedge and effectively prevents injuries and saves lives. Other advantages include more precise directional tree felling, which results in less damage to the tree and an increase in the amount of sellable timber from the tree.

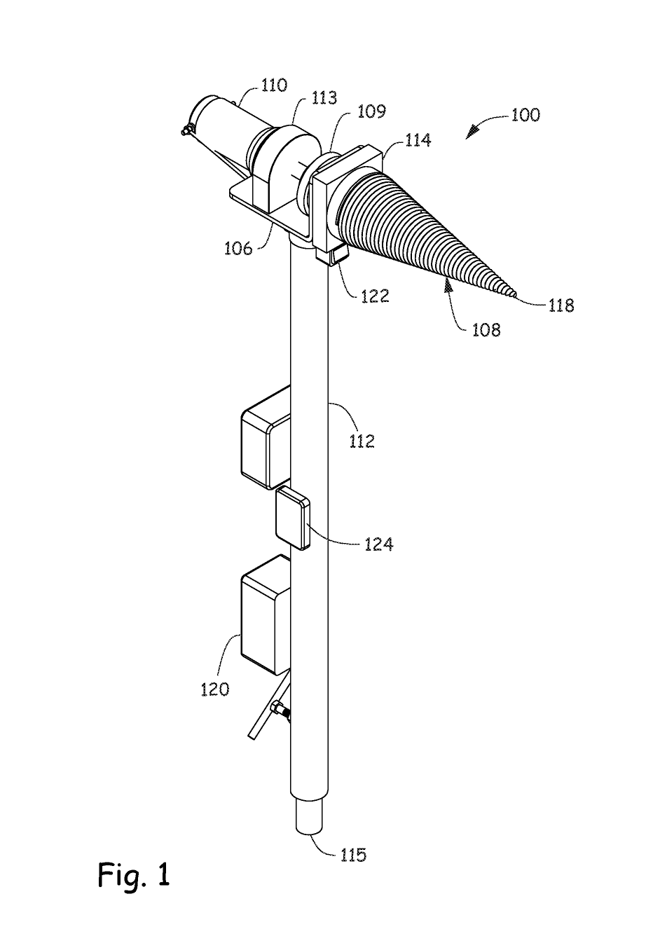

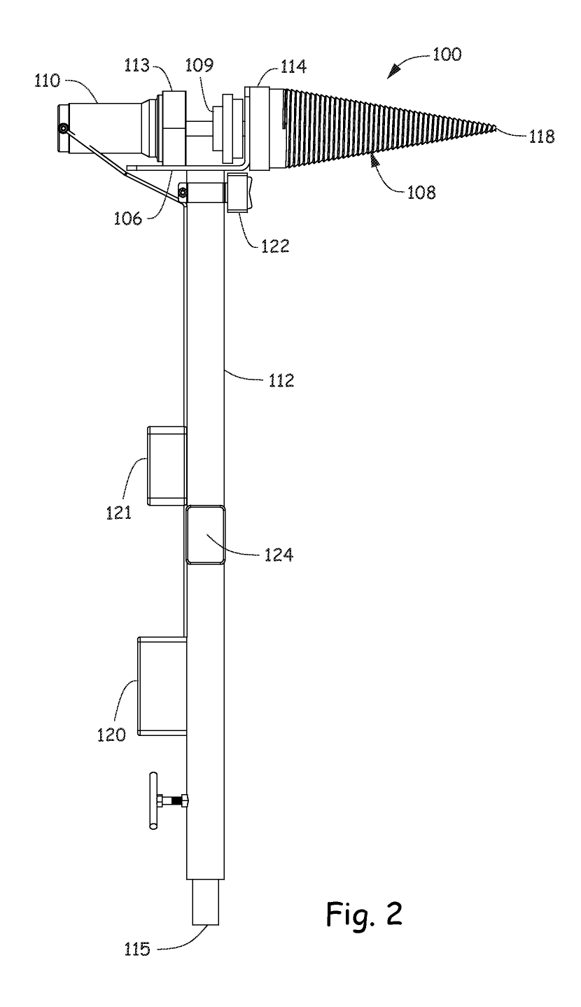

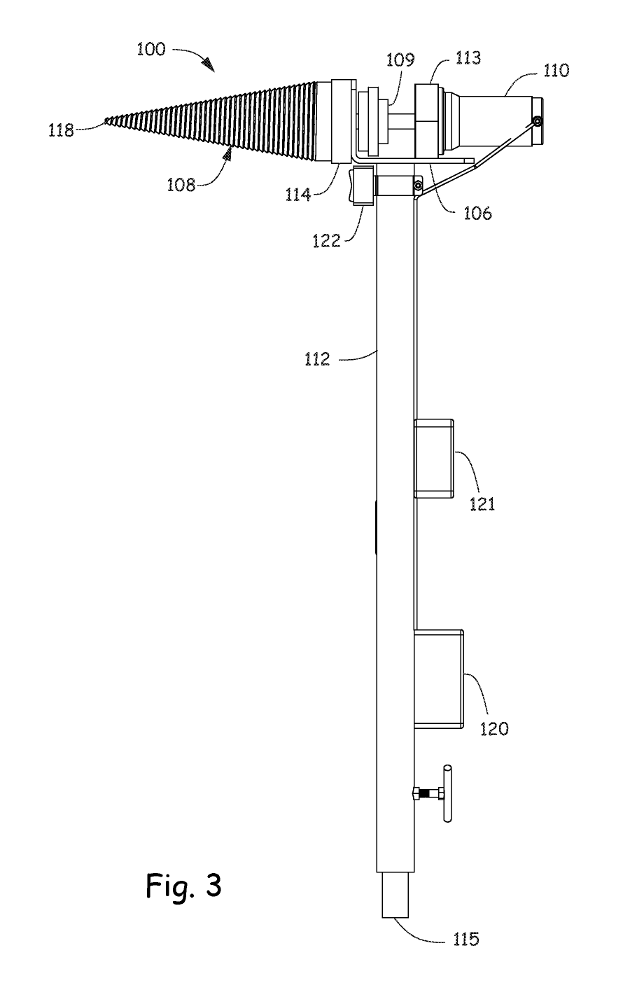

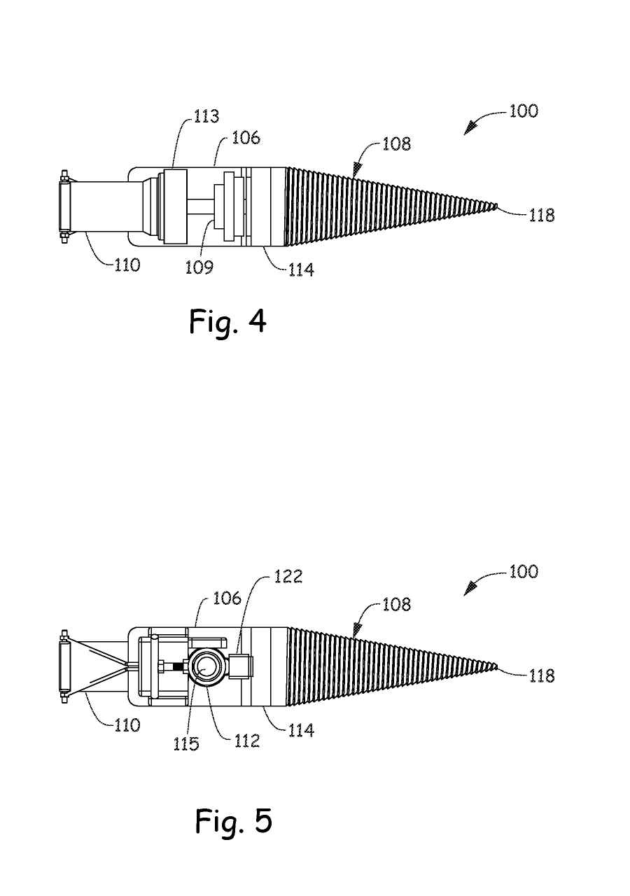

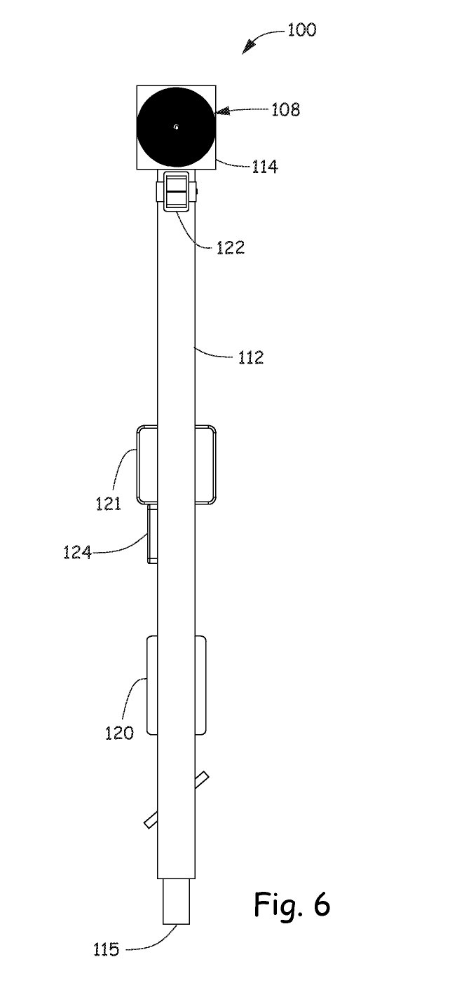

FIGS. 1-6 illustrate a remote power wedge device 100 in accordance with one embodiment. FIG. 1 is a perspective view, FIGS. 2 and 3 are left and right side views, respectively, FIG. 4 is a top view, FIG. 5 is a bottom view and FIG. 6 is a front view. Remote power wedge device 100 includes a base 106, a screw-type cone wedge 108, a motor 110 and a counter-rotational member 112. Screw-type cone wedge 108 is coupled to motor 110 and together screw-type cone wedge 108 and motor 110 are mounted on base 106. Extending from base 106 is counter-rotational member 112. Power wedge device 100 further includes a power coupler 109 that connects motor 110 through a machine block 114 to screw-type cone wedge 108. Screw-type cone wedge 108 couples to power coupler 109 through a through hole in machine block 114. Machine block 114 is mounted to base 106.

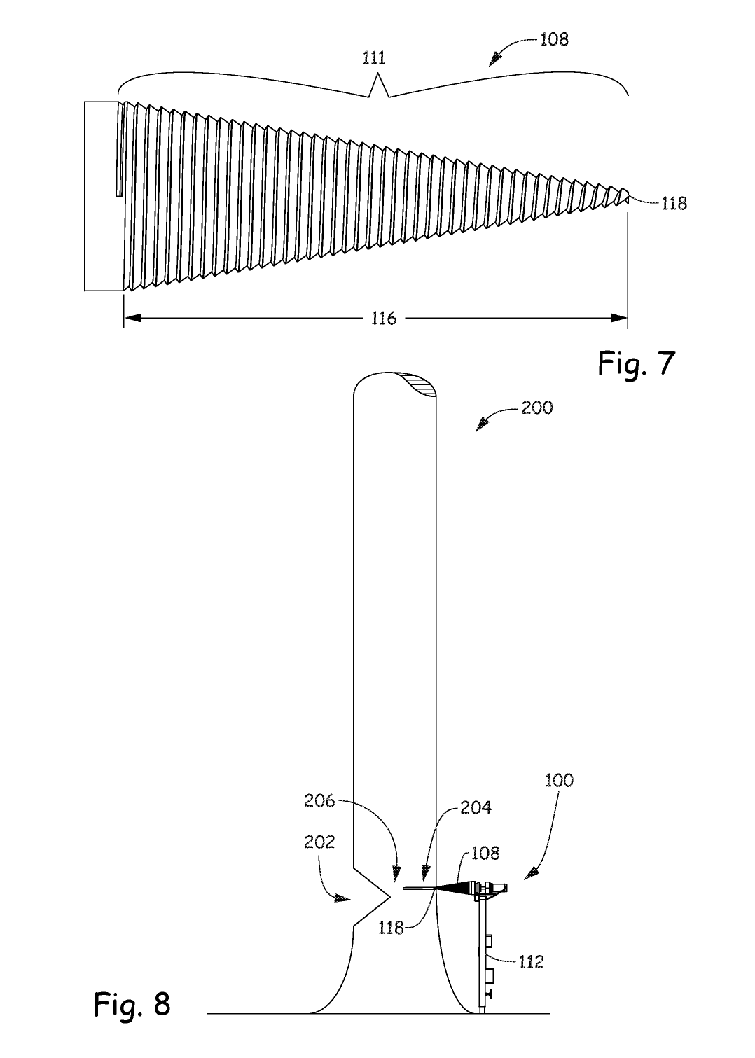

FIG. 7 illustrates an enlarged side view of screw-type cone wedge 108. Screw-type cone wedge 108 includes a cone portion 111 that is in the shape of a cone and therefore tapers to a pointed tip 118, has a threaded exterior surface, and is defined by a length 116 that terminates at the point or pointed tip 118. The screw-type cone wedge 108 illustrated in FIGS. 1-7 is made of steel, however, other materials, such as other metallic materials, are possible. Exemplary materials for making screw-type cone wedge 108 as strong as possible, but also be as light as possible include case hardened aluminum, metal alloys, carbon fiber and etc.

In the embodiment illustrated in FIGS. 1-6, motor 110 is an electric motor that is powered by an onboard battery 120 and is configured to rotatably drive screw-type cone wedge 108. As illustrated in FIG. 1, battery 120 is a removable battery. It can be clipped onto counter-rotational member 112 and connected to motor 110 via battery and remote control relay 121 and can be removed from counter-rotational member 112 to be charged with a battery charger, for example. Of course, battery 120 can also remain clipped to counter-rotational member 112 and be charged in situ by a charger. In this embodiment, power wedge device 100 also includes a gear reduction mechanism 113 that is coupled to motor 110 so that the highest possible torque can be obtained. It should be recognized, however, that other types of motor configurations are possible including a gas powered motor or engine, different configurations of gearing and any other way to power screw-type cone wedge 108.

Counter-rotational member 112 acts like a lever and prohibits power wedge device 100 from spinning when in use. Ways in which counter-rotational member 112 can be grounded or stabilized to ensure threaded cone section 111 is being screwed into a tree to be felled rather than spinning is discussed in detail below in regards to device operation. Regardless, counter-rotational member 112 illustrated in the FIG. 1 embodiment is a rigid, linear member including an elongated rod that extends from base 106, is telescopic to allow the elongated rod to be lengthened or shortened and terminates at a distal end 115. Distal end 115 engages with a ground.

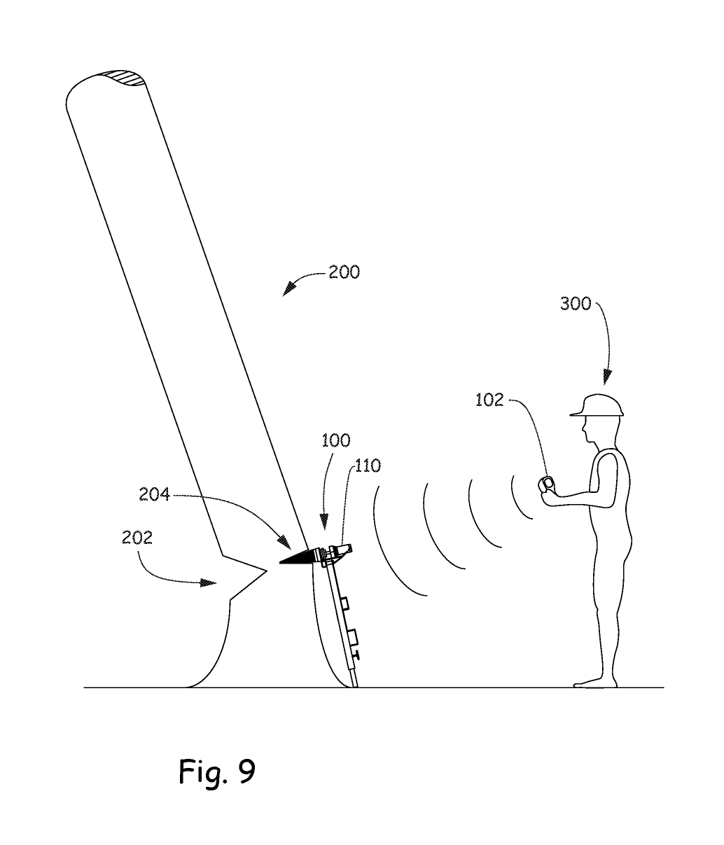

In the embodiment illustrated in FIG. 1, power wedge device 100 also includes two different power on/off switches. First, power wedge device 100 includes battery 120 and remote control circuitry 121, such as a relay, a remote control receiver 124 and an associated remote control transmitter 102 (illustrated in FIG. 9). The combination of these elements allow tree felling device 100 to be powered on and powered off remotely or a safe distance from device 100 using remote control transmitter 102. In particular, remote control circuitry 121 and remote control receiver 124 are located proximal to screw-type cone wedge 108, such as mounted to counter-rotational member 112 as is illustrated in FIG. 1. Remote control transmitter 102 is located remotely from screw-type cone wedge 108 so that motor 110 can be turned on by the remote control transmitter 102 a safe distance from screw-type cone wedge 108.

Second, tree felling device 100 includes a finger trigger 122 that is mounted, in the FIG. 1 embodiment, right below base 106. Trigger 122 starts and stops motor 110 and therefore starts and stops the rotation of screw-type cone wedge 108. In particular, trigger 122 is a forward and reverse trigger so that threaded cone portion 111 can be powered on to rotate in a forward direction or powered on to rotate in a reverse direction. Trigger 122 provides tree felling device 100 with the advantages of a hand held power tool that could serve as a replacement tool in situations where a hammer and wedge could have been used. For example, when a chainsaw gets pinched during normal sawing operations, trigger 122 would allow device 100 to rescue the pinched saw blade and save time for the forester using device 100 along with a chainsaw.

FIG. 8 illustrates a schematic diagram of preparing a tree 200 for felling. FIG. 9 illustrates a schematic diagram of felling tree 200 using power wedge device 100. To prepare the tree for felling by power wedge device 100, standard tree felling preparation procedures are followed. For example, a face cut or notch cut 202 is made on the side of the tree to which the forester wants the tree to fall and includes two cuts so as to notch out a portion of the thickness of the tree. A back cut 204 is a horizontal cut and is made opposite notch cut 202, but does not intersect notch cut 202 so that a hinge section 206 of the tree remains uncut.

As illustrated in FIG. 3, tip 118 of screw-type cone wedge 108 is placed on the exterior surface of the tree at back cut 204. For the power wedge device 100 illustrated in FIGS. 1-6, counter-rotating member 112 is a telescopic member that can be lengthened or shortened so that a distal end of counter-rotating member 115 rests on the ground and tip 118 of screw-type wedge is placed at back cut 204. By resting distal end 115 on the ground, counter-rotational member 112 prevents power wedge device 100 from spinning on its own. The feature of member 112 being telescopic adds versatility, but is not essential or critical for operation. In general, the telescopic member 112 would likely remain fully retracted 95% of the time. It should be realized that other types of counter-rotational members are possible including a U-shaped member that is held to the trunk of the tree under the notch cut and the back cut so that the tree acts as the grounding mechanism. In this way, tip 118 of screw-type cone wedge can be placed any distance from ground depending on the location of the back cut. Other variations include strapping tree felling device 100 to the tree to be felled to ground power wedge device 100.

As illustrated in FIG. 4, after tip 118 of screw-type cone wedge 108 of power wedge device 100 engages with an outer surface of the tree at the back cut 204, a forester 300 stands a safe distance away from the tree 200 to be felled. Using remote control 102, forester 300 powers screw-type cone wedge 108 via motor 110 by a remote control switch on remote control transmitter 102. Screw-type cone wedge 108 begins to drill into back cut 204 spreading out the back cut until screw-type cone wedge 108 forces the tree to begin to fall in the direction to which notch cut 202 is located. In this way, screw-type cone wedge 108 does the job of what a forester would use a hammer and flat wedge for, but now the same job can be accomplished remotely so as to make the entire felling of tree 200 safer to all those involved.

Although elements have been shown or described as separate embodiments above, portions of each embodiment may be combined with all or part of other embodiments described above.

Although the present invention has been described with reference to preferred embodiments, workers skilled in the art will recognize that changes may be made in form and detail without departing from the spirit and scope of the invention.

What is claimed is:

1. A power wedge device comprising:
a base;
a screw-type cone wedge mounted to the base and including a threaded cone portion that tapers to a pointed tip;
a motor mounted to the base and coupled to the screw-type cone wedge to rotatably drive the threaded cone portion; and
a counter-rotational member coupled to the base and configured to ground the screw-type cone wedge so as to prevent the screw-type cone wedge from spinning the motor and the base.

2. The power wedge device of claim 1, wherein the counter-rotational member is an elongated rod that extends from the base and terminates at a distal end, wherein the distal end of the elongated rod engages with a ground.

3. The power wedge device of claim 1, further comprising remote control circuitry coupled to a remote control receiver located on the power wedge device and a remote control transceiver located remotely from the remote control receiver to remotely power the motor to rotatably drive the screw-type cone wedge.

4. The power wedge device of claim 3, wherein the remote control circuitry and the remote control receiver are mounted to the counter-rotational member.

5. The power wedge device of claim 1, wherein the counter-rotational member is telescopic to allow the elongated rod to be lengthened or shortened.

6. The power wedge device of claim 1, further comprising a removable battery mounted to the power wedge device.

7. The power wedge device of claim 6, wherein the removable battery is removably coupled to the counter-rotational member.

8. The power wedge device of claim 1, further comprising a finger trigger mounted below the base to manually power the screw-type cone wedge.

9. A power wedge device comprising:
a screw-type cone wedge mounted to a base and including a threaded cone portion that tapers to a tip, wherein the tip engages with a back cut on a tree to be felled;
a motor mounted to the base and coupled to the screw-type cone wedge to rotatably drive the threaded cone portion; and
an elongated rod that extends from the base and terminates at a distal end, wherein the distal end of the elongated rod engages with a ground so the elongated rod acts as a counter-rotational member to prevent the screw-type cone wedge from spinning the base and the motor.

10. The power wedge device of claim 9, further comprising remote control circuitry coupled to a remote control receiver located on the power wedge device and a remote control transceiver located remotely from the remote control receiver to remotely power the motor to rotatably drive the screw-type cone wedge.

11. The power wedge device of claim 10, wherein the remote control circuitry and the remote control receiver are mounted to the elongated rod.

12. The power wedge device of claim 9, wherein the elongated rod is telescopic to allow the elongated rod to be lengthened or shortened relative to a height of the back cut in the tree to be felled.

13. The power wedge device of claim 9, further comprising a removable battery mounted to the power wedge device.

14. The power wedge device of claim 13, wherein the removable battery is removably coupled to the elongated rod.

15. The power wedge device of claim 9, further comprising a finger trigger mounted below the base to manually power the screw-type cone wedge.

16. A method of felling a tree comprising:
cutting a notch cut into a base of a tree on the side of the tree to which the tree should fall;
cutting a back cut into a base of the tree that is opposite the notch cut but does not intersect the notch cut;
placing a tip of a screw-type cone wedge on an outer surface of the tree at the back cut; and
powering the screw-type cone wedge so that a threaded cone portion of the screw-type cone wedge drills into the back cut until the tree falls.

17. The method of claim 17, wherein powering the screw-type cone wedge comprises remotely controlling a motor that rotatably drives the cone portion of the screw-type cone wedge into the tree.

18. The method of claim 17, wherein placing the tip of the screw-type cone wedge on the outer surface of the tree comprises mounting the screw-type cone wedge to a base and mounting an elongated rod having a distal end to the base and placing the distal end of the elongated rod on the ground to prevent the screw-type cone from spinning the base and the motor.

19. The method of claim 19, further comprising adjusting a height of the elongated rod by telescoping the distal end, wherein the height of the elongated rod is relative to a height of the back cut from the ground.

20. The method of claim 17, wherein powering the screw-type cone wedge comprises using a finger trigger to power a motor to rotatably drive the cone portion of the screw-type cone wedge
